(19) United States
(12) Patent Application Publication
(10) Pub. No.: US 2009/0197520 A1
(43) Pub. Date: Aug. 6, 2009

(54) Automated Warehouse and Method of Supplying Clean Air to the Automated Warehouse

(75) Inventor: Takao HAYASHI, Inuyama-shi (JP)

Correspondence Address: HOGAN & HARTSON L.L.P., 1999 AVENUE OF THE STARS, SUITE 1400, LOS ANGELES, CA, 90067, US

(73) Assignee: MURATA MACHINERY, LTD., Kyoto-shi (JP)

(21) Appl. No.: 12/362,369

(22) Filed: Jan. 29, 2009

(30) Foreign Application Priority Data
Feb. 6, 2008 (JP) 2008-025934

(51) Int. Cl. F24F 11/04; B65G 1/02

(52) U.S. Cl. 454/256; 414/273

(57) ABSTRACT

A position and a speed of a stacker crane, and a position and a speed of an elevation frame are inputted to a clean room controller to correct an amount of supplied clean air, and an amount of discharged air around the stacker crane.

### TECHNICAL FIELD

The present invention relates to an automated warehouse having a carrier vehicle such as a stacker crane. In particular, the present invention relates to prevention of contamination of stored articles due to wind generated by traveling of the carrier vehicle.

### BACKGROUND ART

Automated warehouses like clean rooms have problems of contamination of stored articles due to atmosphere in the vicinity of floors by wind blown up by a carrier vehicle such as a stacker crane. In the automated warehouses, since racks or processing equipment are provided on both sides of traveling space of the stacker crane, atmosphere blown up on a front side in a running direction of the carrier vehicle flows toward a back side along the traveling space. The atmosphere bow up on the front side in the running direction flows toward an area on the back side in the running direction of the stacker crane where a negative pressure is generated. In the meanwhile, the atmosphere enters nearby racks, and contaminates stored articles. Air flow generated by traveling of the carrier vehicle will be referred to as the “travel wind”.

In an attempt to address the problem, according a proposal in Patent Publication 1 (JP2000-16520A), wind barriers are provided on both of front and back sides of a stacker crane to rectify the travel wind, and space is provided between a running vehicle under the stacker crane and a rack to release the travel wind. However, when space is provided between the running vehicle and the rack, storage efficiency is lowered, or the running vehicle needs to be designed to have a smaller size.

### DISCLOSURE OF THE INVENTION

### Problems to be Solved by the Invention

An object of the invention is to reduce contamination of stored articles in an automated warehouse due to travel wind generated by a carrier vehicle.

### Means for Solving the Problems

According to the present invention, an automated warehouse includes racks on both of left and right sides of traveling space of a carrier vehicle, and supply means for supplying clean air into the rack. The supply means is provided on a back side of the rack as viewed from the traveling space. An exhaust port is provided at a bottom of the traveling space or the rack. The automated warehouse further includes detection means for detecting a position and a running direction of the carrier vehicle, and air supply control means for controlling an amount of the clean air supplied to the rack to a first level on a front side in the running direction of the carrier vehicle, and to a second level that is less than the first level on a side portion or on a back side in the running direction of the carrier vehicle and is larger than an average value of clean air supply in other positions of the rack.

According to a method of the present invention, racks are provided on both of left and right sides of traveling space of a carrier vehicle.

The method includes the steps of supplying clean air into the rack from a back of the rack as viewed from the traveling space, discharging atmosphere from a bottom of the traveling space or the rack, detecting a position and a running direction of the carrier vehicle, and controlling an amount of the clean air supplied to the rack to a first level on a front side in the running direction of the carrier vehicle, and to a second level that is less than the first level on a side portion or on a back side in the running direction of the carrier vehicle and is larger than an average value of clean air supply in other positions of the rack.

Preferably, the detection means detects a speed of the carrier vehicle, and the air supply control means increases the amount of the supplied clean air at the first level and the second level as the speed of the carrier vehicle gets higher.

Further, preferably, the air supply control means makes the amount of the clean air supplied to an occupied rack cell of the rack larger than the amount of the clean air supplied to a vacant rack cell of the rack.

Preferably, an amount of air discharged from the exhaust port is controlled to a third level on the front side in the running direction of the carrier vehicle, and to a fourth level that is less than the third level on the side portion or on the back side in the running direction of the carrier vehicle and is larger than an average value of air discharge in other positions of the rack.

Further, preferably, the carrier vehicle has a mast and an elevation frame, the detection means further detects a height and an elevation direction of the elevation frame, and the air supply control means increases the amount of the clean air supplied to the rack on a front side in the elevation direction of the elevation frame.

In the present invention, description regarding the automated warehouse is directly applicable to description regarding the method of supplying clean air to the automated warehouse.

More preferably, the running direction or the elevation direction are determined based on the traveling speed or the elevation speed. Supply of the clean air to the rack may be performed for each rack cell or for each of units of rack cells that are arranged vertically.

The atmosphere means air in traveling space or the like.

The amount of clean air supplied to the rack may be changed depending on the position, whether it is the side portion of the carrier vehicle or the back side in the running direction of the carrier vehicle, as long as the amount of supplied clean air is smaller than the first level, and larger than the amount of supplied clean air to the other positions of the rack.

The amount of clean air supplied to the rack and the amount of discharged air along the running direction may be controlled in the same pattern, or may be controlled in different patterns.

### ADVANTAGES OF THE INVENTION

In the present invention, depending on the position and the running direction of the carrier vehicle, the amount of clean air supplied to the rack is controlled. In this manner, entry of atmosphere into rack by the positive pressure generated on the front side in the running direction of the carrier vehicle is suppressed. Then, by the air flow toward the back side in the running direction, entry of atmosphere into the rack from the side surface of the carrier vehicle is suppressed. Further, by reducing the negative pressure generated on the back side in the running direction by the clean air, blowing up of atmosphere in the vicinity of the floor space is suppressed.

As the speed of the carrier vehicle gets higher, the amount of supplied clean air is increased. That is, in the case where the carrier vehicle travels at high speed and the influence of the carrier vehicle is large, by increasing the amount of supplied clean air at the first level and the second level, supply of the clean air can be carried out in a manner to suppress the influence. “As the speed gets higher, the amount of supplied clean air is increased” herein means that the amount of supplied clean air is changed stepwise, in a plurality of levels in accordance with the speed of the carrier vehicle.

By increasing the amount of clean air supplied to the occupied rack cell of the rack in comparison with the amount of clean air supplied to the vacant rack cell of the rack, while making up for the disadvantage of non-smooth flow of clean air in the occupied rack cell, contamination of the article is prevented reliably. In the case where the amount of supplied clean air cannot be controlled for each of the rack cells of the rack, the amount of supplied clean air should be changed depending whether the area has a lot of occupied rack cells or a small number of vacant rack cells.

By correcting the amount of discharged air depending on the position and running direction of the carrier vehicle, the positive pressure generated on the front side in the running direction of the carrier vehicle is reduced by increasing the amount of discharged air, and blowing up of atmosphere in the vicinity of the floor surface toward the area where negative pressure is generated on the back surface in the running direction of the carrier vehicle is suppressed. Further, entry of atmosphere into the rack from the side surface in the running direction of the carrier vehicle is suppressed by increasing the amount of discharged air.

Further, by increasing the amount of clean air supplied to the rack on the front side in the elevation direction of the elevation frame, backflow of atmosphere into the rack due to the positive pressure generated on the front side in the elevation direction of the elevation frame is suppressed.

### BRIEF DESCRIPTION OF THE DRAWINGS

FIG. 1 is a plan view showing main components of an automated warehouse according to an embodiment.

FIG. 2 is a cross sectional view in a vertical direction, showing main components of the automated warehouse according to the embodiment.

FIG. 3 is a model showing correction of an amount of supplied air and an amount of discharged air in the embodiment.

FIG. 4 is a flow chart showing an algorithm for correction of the amount of the supplied air and the amount of discharged air in the embodiment.

### DESCRIPTION OF THE NUMERALS

2: automated warehouse
4: traveling space
6: rack
8: stacker crane
10: travel rail
12: magnetic mark
14: crane controller
16: clean room controller
18: exhaust fan
20: elevation frame
22: mast
24: turn table
26: transfer apparatus
28, 40: cassette
30: running vehicle
32: running motor
34: drum
36: on board controller
42: support column
46: duct
48: fan filter unit
50: waffle
52: running wheel
54: linear sensor
56: valve
60: support member

### EMBODIMENT

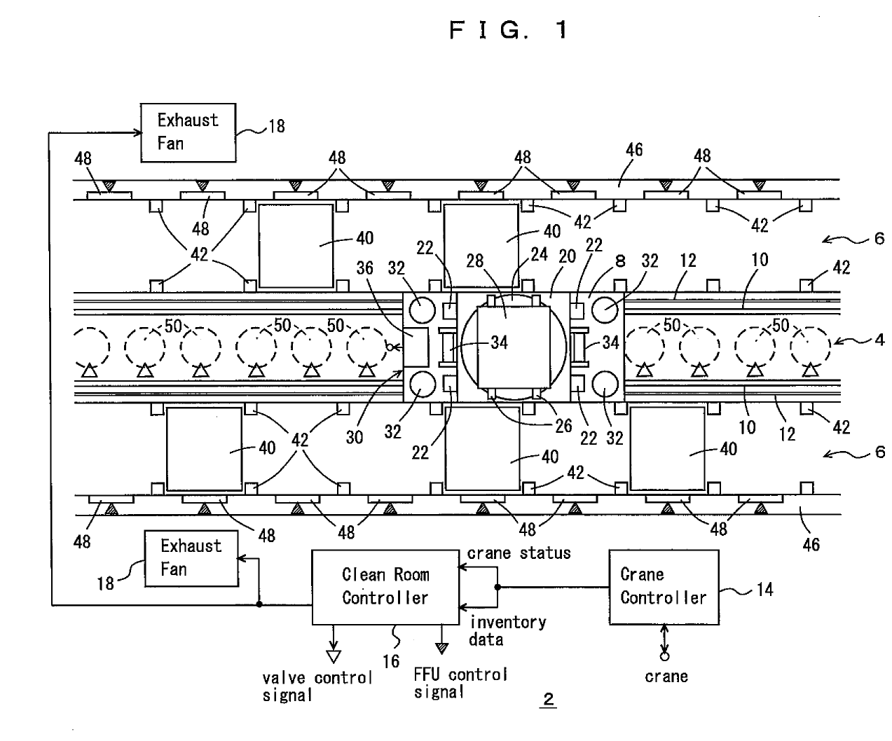

FIGS. 1 to 4 show an automated warehouse 2 according to an embodiment. In the drawings, a reference numeral 4 denotes traveling space, and racks 6 are provided on both of left and right sides of the traveling space 4. It should be understood that processing equipment such as a liquid crystal substrate may be provided on a back surface side of the rack 6 as viewed from the traveling space 4. The traveling space 4 is a passage for a stacker crane 8. Reference numerals 10 denote travel rails, and reference numerals 12 denote magnetic marks. Though a pair of left and right travel rails 10 are used in the embodiment, only one travel rail 10 may be used sufficiently. For example, a pair of magnetic marks 12 may be provided in parallel with the travel rails 10 so that the stacker crane 8 can constantly recognize the current position of the stacker crane 8.

Instead of detecting the absolute position using the magnetic marks 12, the current position of the stacker crane 8 may be determined by an encoder provided along a travel axis of the stacker crane 8. When the current position is determined, the speed is determined by time differentiation. The speed herein means velocity having an orientation. In the case where the position and speed with respect to the time axis are given as an instruction function, and servo control for the stacker crane 8 is implemented such that the actual position and speed are substantially in accordance with the instruction function, the position and speed for the servo control should be transmitted from the stacker crane 8 to a ground controller for controlling supply of clean air and discharge of atmosphere. The type and structure of carrier vehicles may be determined arbitrarily.

A reference numeral 14 denotes the ground controller. The ground controller 14 communicates with an on board controller 36 of the stacker crane 8 for sending transportation instructions to the stacker crane 8, and receiving data such as transportation results and the current position from the stacker crane 8. A clean room controller 16 controls supply of clean air and discharge of atmosphere in the clean room where the automated warehouse 2 is provided. A reference numeral 18 denotes an exhaust fan for discharging atmosphere from waffles 50 or the like.

The stacker crane 8 has an elevation frame 20, and the elevation frame 20 is elevated and lowered along a mast 22. For example, a turn table 24 and a transfer apparatus 26 are provided for the elevation frame 20 such that a cassette containing liquid substrates or the like is transferred between the elevation frame 20 and the rack 6. A reference numeral 28 denotes the cassette on the elevation frame 20. The stacker crane 8 has a running vehicle 30. For example, the running vehicle 30 travels along the travel rails 10 by four running wheels 52. A reference numeral 32 denotes a running motor and a reference numeral 34 denotes a drum for winding and unwinding a suspension member to elevate and lower the elevation frame 20. The drum 34 is rotated by an elevation motor (not shown).

A reference numeral 36 denotes the on board controller for controlling traveling of the stacker crane 8, elevation of the elevation frame 20, and operation of the turn table 24 and the transfer apparatus 26, and transmitting data such as the current position in the running direction, the traveling speed, and the current height position and elevation speed of the elevation frame 20 to the crane controller 14. The crane controller 14 keeps track of the inventory status of the racks 6, and transmits data such as respective storage positions of the racks 6, i.e. data indicating whether rack cells are occupied or vacant and data indicating the status of the stacker crane 8, to the clean room controller 16. For example, the status of the stacker crane 8 may include the current position and the current speed, the height and the elevation speed, and data indicating occupancy or vacancy. It should be understood that data regarding the status of the stacker crane 8 may be directly transmitted from the stacker crane 8 to the clean room controller 16.

Reference numerals 42 denote support columns. On a back surface as viewed from the traveling space 4 of the rack 6, a duct 46 is provided. For example, a fan filter unit 48 is provided for each of rack cells, and the clean air sucked from the duct 46 is supplied into the rack cell. Further, the waffles 50 are provided at the bottoms of the traveling spaces 4 or the racks 6 for sucking the atmosphere by the exhaust fan 18 back to the duct 46. The clean room controller 17 controls the amount of the wind supplied by the respective fan filter units 48, and orientation of wind direction plate to control the amount of the supplied clean air to each of the rack cells, and the flow orientation of the clean air. By controlling valves 56 provided between the waffles 50 and the exhaust pipe, the amount of discharged air is controlled.

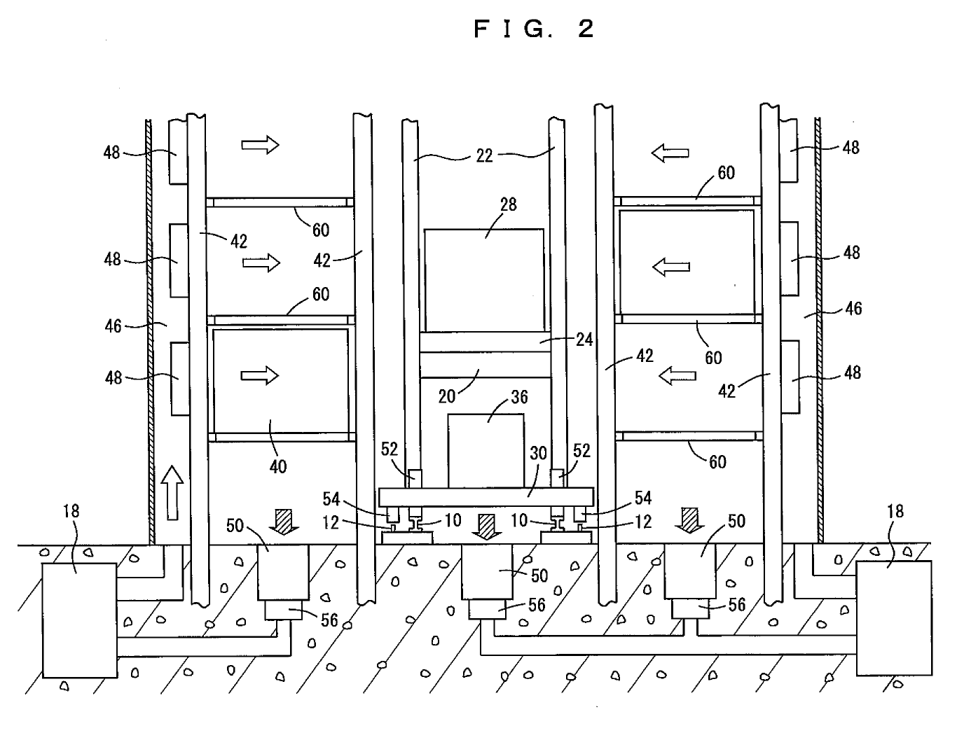

The running vehicle 30 of the stacker crane 8 has running wheels 52 to travel on the rails 10. For example, a pair of left and right linear sensors 54 are used to recognize the magnetic marks 12 to calculate the current position. As shown in FIG. 2, the valves 56 are provided at the bottoms of the waffles 50, and support members 60 as shown in FIG. 2 are provided at the support columns 42 to support the cassettes 40. Partitions may be provided between respective rack cells to interrupt fluid flows between the rack cells. Alternatively, fluid flow between the rack cells may not be interrupted necessarily.

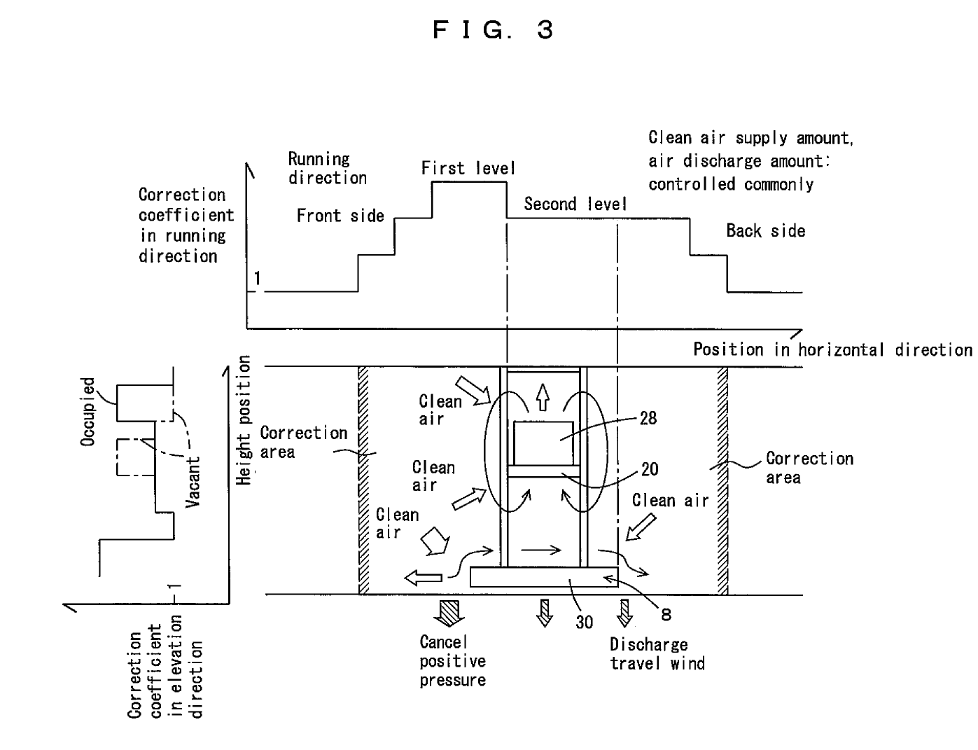

FIG. 3 shows a model of supply of clean air and discharge of air in the embodiment. In FIG. 3, it is assumed that the stacker crane 8 travels from the right side to the left side, the elevation frame 20 is elevated upwardly, and the cassette 28 is placed on the elevation frame 20. By the travel of the stacker crane 8, atmosphere on the front side in the running direction of the running vehicle 30 is blown up. Since racks are provided on both of the left and right sides of the traveling space, most of the atmosphere that has been blown up flows backwardly in the running direction along upper portion of the running vehicle 30. Since a negative pressure is generated on the back side of the running vehicle 30, the atmosphere that has been blown up flows into the area having the negative pressure. The negative pressure creates turbulent flow that further blows up atmosphere in the vicinity of the floor space. When the elevation frame 20 is elevated or lowered, a positive pressure is generated on the front side of the elevation frame 20 in the elevation direction, and the atmosphere flows into the part where the negative pressure is generated on the back side in the elevation direction of the elevation frame 20. The travel wind is denoted by solid lines in FIG. 3.

In order to prevent contamination of the cassette 40 in the rack by the travel wind or contamination of the cassette 40 on the elevation frame 28, a large amount of clean air is supplied to the rack on the front side in the running direction of the crane 8 to prevent entry of atmosphere into the rack by the positive pressure. Further, on the front side in the running direction of the crane 8, by increasing an amount of air discharged from the waffle, the positive pressure is cancelled. Also on side surfaces of the stacker crane 8 in the running direction, the amount of clean air supplied to the rack, and the amount of discharged air are increased to prevent entry of atmosphere into the rack by the travel wind. Further, also on the back side in the running direction of the stacker crane 8, the amount of clean air supplied to the rack, and the amount of air discharged from the waffle are increased so that the negative pressure is reduced, and entry of atmosphere into the rack is prevented. Further, instead of blowing up atmosphere in the vicinity of the floor space by the negative pressure, the atmosphere is discharged from the waffle. Influence of the travel wind is significant in the running vehicle or in an area above the running vehicle. Since the clean air from the rack is blown out from a position above the running vehicle, the clean air functions to regulate the travel wind to flow downwardly.

In the elevation direction of the elevation frame 20, a positive pressure is generated on the front side in the elevation direction, and a negative pressure is generated on the back side in the elevation direction. In the presence of the positive pressure and the negative pressure, the amount of clean air supplied to the rack can be used as control means. The amount of supplied clean air is increased on the front side in the elevation direction of the elevation frame 20, and the amount of supplied clean air is slightly increased on the side surfaces of the cassette 28 or on the back side in the elevation direction of the elevation frame 20 in comparison with the other areas.

An area where the amount of supplied clean air and the amount of air discharged from the waffle are changed by travel or elevation of the stacker crane 8 is used as a correction area. It is assumed that the amount of supplied clean air to the rack in areas other than the correction area have an average value of, e.g., “1”. A correction coefficient used for correction is determined for each of the running direction of the crane 8 and the elevation direction of the elevation frame 20. The correction coefficient is gradually increased from 1 inside the correction area. On the front side in the running direction of the crane 8, the correction coefficient becomes a first level which is the maximum level, and the correction coefficient becomes a second level on the side surfaces or the back side in the running direction of the crane 8. The correction coefficient in the running direction is used commonly for the amount of clean air supplied to the waffle, and the amount of air discharged from the rack. The amount of supplied clean air, and the amount of discharged air may be different on the side surfaces of the crane 8, and on the back side in the running direction of the crane 8. Further, it is not necessary to process the amount of supplied clean air and the amount of air discharged from the waffle using a common correction coefficient.

The correction coefficient in the elevation direction is shown on the left side. In order to cancel the travel wind, the amount of supplied clean air is multiplied, e.g., by “A” for rack cells at the lowest level or at any of two or three levels from the bottom. In this manner, the travel wind is regulated to flow downwardly. Next, in the case where the cassette 28 is present in the elevation frame 20, as shown by a solid line, on the front side of the cassette 28 in the elevation direction, the amount of the supplied clean air is increased by “B”, and also on the back side of the elevation frame 20 in the elevation direction from the height same as the cassette 28, for example, the amount of supplied clean air is increased by “C”. Here, A>B>C>1. In the case where the rack cell is vacant, the amount of clean air supplied to the rack cell in the vicinity of the running vehicle is increased, the amount of supplied clean air on the front side in the elevation direction is increased, and the amount of supplied clean air on the back side is increased. In this manner, the positive pressure by elevation and lowering of the elevation frame 20 is cancelled to prevent entry of the travel wind into the rack cell facing the cassette 28 or the like, and the negative pressure on the back side in the elevation direction is cancelled.

The actual correction coefficient is determined, e.g., by multiplying the correction coefficient in the running direction and the correction coefficient in the elevation direction. Instead of the correction coefficient, the correction value of the amount of supplied clean air or the amount of discharged clean air may be determined. Further, since the travel wind becomes significantly strong as the increase in the travel speed and elevation speed of the crane 8, for example, the correction coefficient is increased in proportion to the absolute value of the travel speed or the elevation speed. The speed may have a low resolution. For example, only four levels (stop, low speed, middle speed, high speed) may be available, or only two levels (stop, moving) are available.

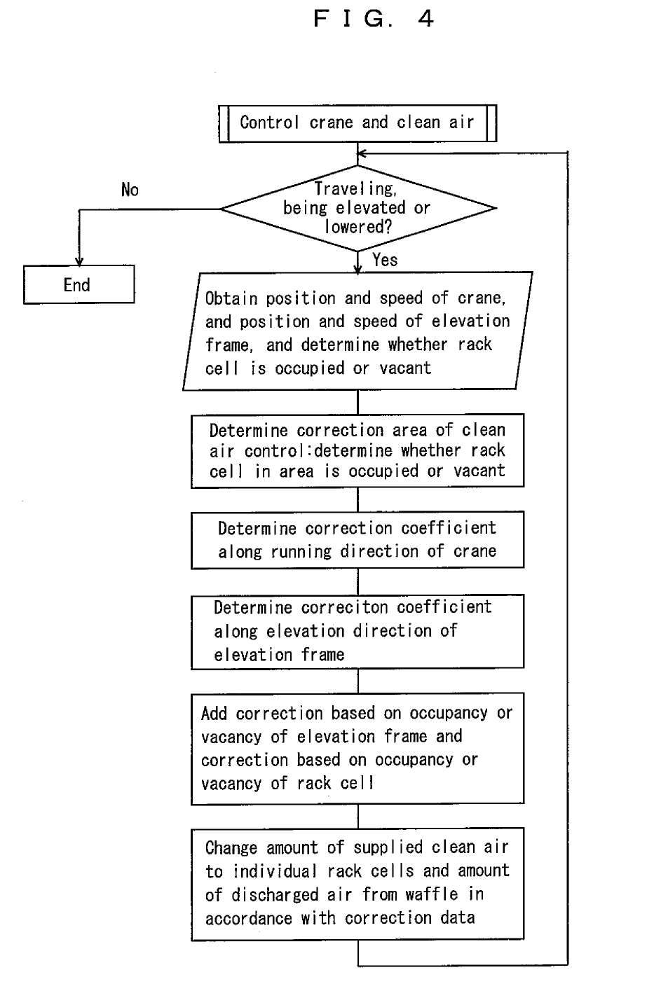

FIG. 4 shows an algorithm for controlling clean air in the embodiment. If the crane is neither in the middle of traveling nor in the middle of being elevated or lowered, this algorithm is stopped. In the case where the crane is in the middle traveling or in the middle of being elevated or lowered, the position and speed of the crane, the height and elevation speed of the elevation frame, and whether the rack cell is vacant or occupied are determined. These items of data are determined, e.g., by a linear sensor of the stacker crane, a control motor of the elevation frame, and transportation instructions. Depending on the position of the crane, the correction area is determined. It is determined whether the rack cell is vacant or occupied. In the occupied rack cell, it is required to prevent contamination of articles. Further, since the clean air does not flow smoothly inside the occupied rack cell, the amount of clean air supplied to the occupied rack is increased in comparison with the amount of clean air supplied to the vacant rack cell. Then, the correction coefficient along the running direction of the crane is determined. This correction coefficient is determined depending on the position, whether it is the front side in the running direction of the stacker crane, the side surface position or the back side position along the running direction. As the increase in the absolute value of the traveling speed of the crane, the correction coefficient becomes large. This correction coefficient is used for controlling the amount of clean air supplied to the rack, and the amount of air discharged from the floor surface or the like.

The correction coefficient along the elevation direction of the elevation frame is determined. The correction coefficient becomes the maximum at the article or at the rack cell on the front side in the elevation direction of the elevation frame. The correction coefficient at the rack cell on the side surface of the article or the elevation frame, and the rack cell on the back side in the elevation direction is smaller than the correction coefficient for the rack cell on the front side in the elevation direction. Further, for the rack cells at the lowest level to the second to third levels from the bottom, large correction coefficients are selected. Further, the correction coefficient in the elevation direction for the respective rack cells are changed between the solid line and the chain line of FIG. 3, depending on whether the rack cells are occupied or vacant. Further, for each of the rack cells, the amount of supplied clean air is changed depending on whether the rack cell is occupied or vacant. The degree of correction is changed also depending on the traveling speed and the elevation speed. If the absolute values of the traveling speed and the elevation speed are large, a large correction coefficient is adopted. By integrating these parameters, correction data for the amount of clean air supplied to each rack cell is determined, and supply of clean air to individual rack cell is controlled. Further, the amount of gas discharged from the waffle is controlled based on the correction data.

The embodiment has the following features.

(1) Based on the position and speed of the stacker crane, and the position and speed of the elevation frame, the amount of clean air supplied to the rack, and the amount of air discharged from the waffle are changed.
(2) Even if the positive pressure is generated on the front side in the running direction of the running vehicle, by controlling the amount of clean air supplied to the rack, entry of atmosphere into the rack is prevented, and entry of atmosphere into the rack is also prevented on the side surfaces and the back side in the running direction of the running vehicle. Further, blowing up of air in the vicinity of the floor space by the negative pressure on the back side in the running direction of the running vehicle is prevented.
(3) By correcting the amount of air discharged from the waffle, the positive pressure generated on the front side in the running direction of the running vehicle is cancelled, and blowing up of atmosphere in the vicinity of the floor space toward the area where the negative pressure is generated is prevented. Further, entry of atmosphere into the rack from the side surface in the running direction of the running vehicle is prevented by air discharged from the waffle.
(4) Likewise, backflow of atmosphere into the rack by the positive pressure generated on the front side in the elevation direction of the elevation frame is prevented, and backflow of atmosphere into the rack cell facing the article on the elevation frame and the rack cell on the back side in the elevation direction are prevented.
(5) By increasing the amount of clean air supplied to the occupied rack cell in comparison with the amount of clean air supplied to the vacant rack cell, contamination of the article is reliably prevented.

In the embodiment, an example of providing the fan filter unit for each of the rack cells is provided. Alternatively, the fan filter unit may be provided at the inlet side of the duct. Further, though the amount of wind is controlled in the embodiment, control of the wind direction plate in the fan filter unit may be implemented additionally. The type of the carrier vehicle can be determined arbitrarily.

1. An automated warehouse including racks on both of left and right sides of traveling space of a carrier vehicle, and supply means for supplying clean air into the rack, the supply means being provided on a back side of the rack as viewed from the traveling space, an exhaust port provided at a bottom of the traveling space or the rack, the automated warehouse further including:
detection means for detecting a position and a running direction of the carrier vehicle; and
air supply control means for controlling an amount of the clean air supplied to the rack to a first level on a front side in the running direction of the carrier vehicle, and to a second level that is less than the first level on a side portion or on a back side in the running direction of the carrier vehicle and is larger than an average value of clean air supply in other positions of the rack.

2. The automated warehouse according to claim 1, the detection means further detecting a speed of the carrier vehicle, and the air supply control means increasing the amount of the supplied clean air at the first level and the second level as the speed of the carrier vehicle gets higher.

3. The automated warehouse according to claim 1, the air supply control means making the amount of the clean air supplied to an occupied rack cell of the rack larger than the amount of the clean air supplied to a vacant rack cell of the rack.

4. The automated warehouse according to claim 1, further comprising air discharge control means for controlling an amount of air discharged from the exhaust port to a third level on the front side in the running direction of the carrier vehicle, and to a fourth level that is less than the third level on the side portion or on the back side in the running direction of the carrier vehicle and is larger than an average value of air discharge in other positions of the rack.

5. The automated warehouse according to claim 4, the carrier vehicle having a mast and an elevation frame, the detection means further detecting a height and an elevation direction of the elevation frame, and
the air supply control means making the amount of the clean air supplied to the rack on a front side in the elevation direction of the elevation frame larger than the average value of clean air supply.

6. A method of supplying clean air to an automated warehouse including racks on both of left and right sides of traveling space of a carrier vehicle, the method comprising the steps of:
supplying clean air into the rack from a back of the rack as viewed from the traveling space;
discharging atmosphere from a bottom of the traveling space or the rack;
detecting a position and a running direction of the carrier vehicle; and
controlling an amount of the clean air supplied to the rack to a first level on a front side in the running direction of the carrier vehicle, and to a second level that is less than the first level on a side portion or on a back side in the running direction of the carrier vehicle and is larger than an average value of clean air supply in other positions of the rack.
